(19) United States
(12) Patent Application Publication
(10) Pub. No.: US 2025/0095427 A1
(43) Pub. Date: Mar. 20, 2025

(54) SECURITY CONTAINER CASSETTE FOR BANKNOTES OR VALUABLES FOR ATMS OR CASH MACHINES

(71) Applicant: M.I.B. S.r.l., Milano (IT)

(72) Inventor: Giuseppe Ezio FUMANELLI, MELZO (IT)

(21) Appl. No.: 18/763,662

(22) Filed: Jul. 3, 2024

(30) Foreign Application Priority Data
Sep. 19, 2023 (IT) 202023000003861

(51) Int. Cl. G07D 11/125

(52) U.S. Cl. CPC G07D 11/125

(57) ABSTRACT

A security container cassette (1) for banknotes or valuables (50) for cash machines or ATMs, defining an internal volume (1a) and comprising perimeter walls (10) including an upper wall (11), said upper wall (11) developing along an upper surface (11a) and comprising: a frame (12) structurally in one piece with at least part of the other perimeter walls (10), a main opening (13) occupying most of the upper wall (10), a main container (2) arranged in the internal volume (1a) and main opening (13) and comprising: an upper side (20) developing along the upper surface (11a) and covering the main opening (13) and at least part of the frame (12), the upper side being provided with passing through upper openings (20a), a lower side (21), arranged within the main volume (1a) and comprising passing through lower openings (21a), side walls (22) suitable for connecting the upper side (20) and the lower side (21), constraint means (4) suitable for rigidly constraining the upper side (20) to the frame (12); an internal container (3) inside the main container (2), fluid-tight and configured to contain marking fluid.

This invention relates to a security container cassette for banknotes or valuables, in particular a cassette for Bancomat (i.e. cash machines), ATMs, and the like of the type specified in the preamble of the first claim.

Different types of security containers for banknotes or valuables are currently known, such as cassettes for ATM cash machines, or similar containers for transporting banknotes and other items.

Said containers, in particular in the case of cassettes for cash machines, ATMs, and the like, are exposed to theft and break-in attempts.

In order to address these drawbacks, active invalidating marking systems have been designed to mark the banknotes contained in the cassettes. These comprise break-in sensors that, in the event of an alarm, activate means designed to mark the banknotes and valuables contained in the cassettes with indelible ink so that they cannot be used.

For example, similar marking means are described in the Italian patent IT MI2001A000946, of the applicant itself.

These active marking systems are very effective. In the case of break-ins using explosives, however, these create significant shock waves, and in many cases the banknotes in the cassettes can be ejected or separated from the marking system during the explosion, making the marking system ineffective.

The patent application DE202018105701U1, filed in 2018, seeks to address said drawback by providing a cassette that includes a pliable tank with marking ink inside, placed near the banknotes.

In case of bursting, said tank breaks, automatically marking the banknotes and valuables in the cassettes, making them unusable.

A similar solution was already implemented in many different cassettes and containers, and was, for example, described in patent documents: EP1653037A1, published in 2006, GB1138104A, published in 1968, and U.S. Pat. No. 5,156,272A, published in 1992.

These devices, while improving the situation, do not completely solve the technical problem.

In fact, the described pliable tank of marking ink positioned above the banknotes is not always broken by the explosion and especially when a limited quantity of explosives, or a low potential explosive, is used.

Other times, the tank breaks in places where there are no banknotes.

The applicant's own patent application EP3761276A1 remedies said drawbacks by making a cassette that includes a pliable tank above which, along the upper wall of the cassette that divides the outside of the cassette from the said pliable tanks, are placed holes or weakened portions that, in the event of an explosion, allow the shock wave to pass directly to the pliable tanks and result in their rupture.

The structure described in patent application EP3761276A1 can also be realized as an aftermarket modification and with any cash machine, ATM and similar cassette. However, said implementation is quite complex and arduous, because it requires precise drilling of the top portion of the cassette and machining to insert the various containers described.

The same patent application EP3761276A1 describes an embodiment, illustrated in FIG. 7 and described in paragraphs 57-61.

In such an embodiment, a lid, of the traditional type, can be provided with two large openings through which pliable containers or tanks are arranged, together with their outer containers. The latter can be equipped with connection flanges, made of polymeric material like the rest of the container, designed to attach with an rigid constraint said containers to the cassette lid, by means of connection such as screws or glue.

Such an embodiment greatly simplifies the aftermarket application of said safety systems but important drawbacks remain.

In particular, this solution increases the thickness of the cassette and is laborious in any case.

In this context, the technical task underlying this invention is to devise a security container cassette for banknotes and valuables, in particular a cassette for cash machines, ATMs and the like, that is capable of substantially overcoming at least some of the above-mentioned drawbacks.

Within the scope of said technical task, an important objective of the invention is to obtain a security container cassette for banknotes or valuables, especially a cassette for cash machines, ATMs and the like that is secure and easy to apply even as an aftermarket modification.

The technical task and specified purposes are achieved with a security container cassette for banknotes or valuables, in particular a cassette for cash machines, ATMs and the like, as claimed in the appended claim 1.

Preferred embodiments are highlighted in the dependent claims.

The characteristics and benefits of the invention will be clarified in the following detailed description of some preferred embodiments of the invention, with reference to the accompanying drawings, wherein:

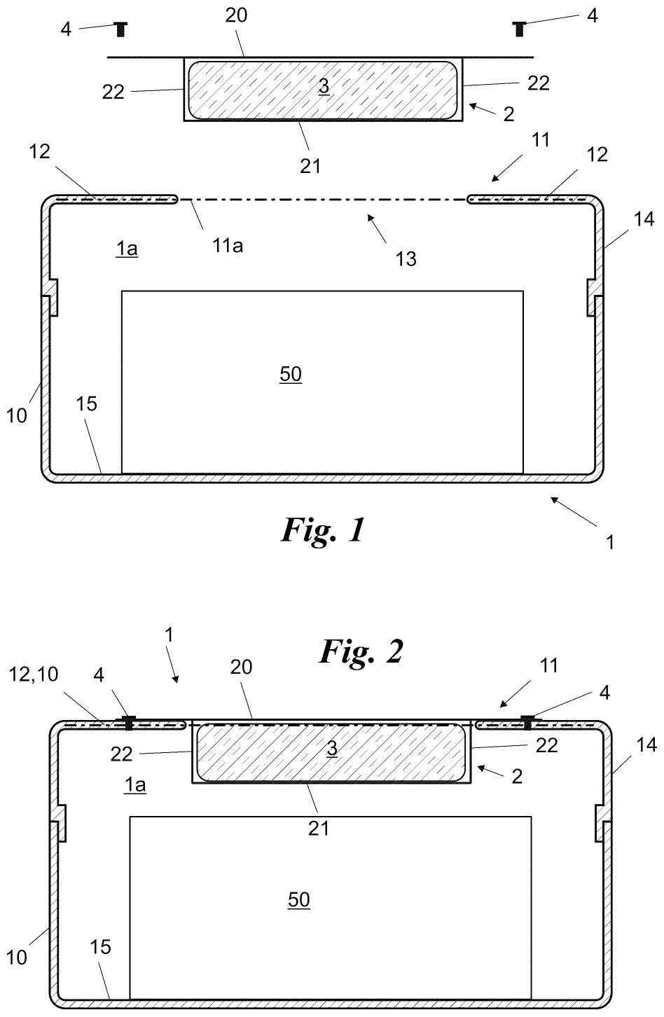

FIG. 1 shows the container cassette according to the invention in exploded and cross-section views;

FIG. 2 shows the container cassette according to the invention in cross-section view;

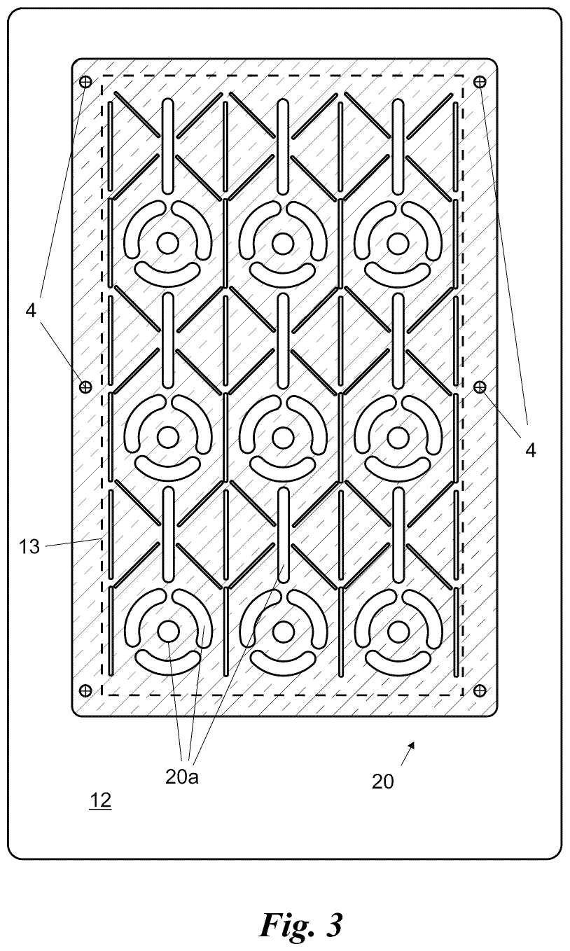

FIG. 3 shows the top view of the interior of the container cassette according to the invention;

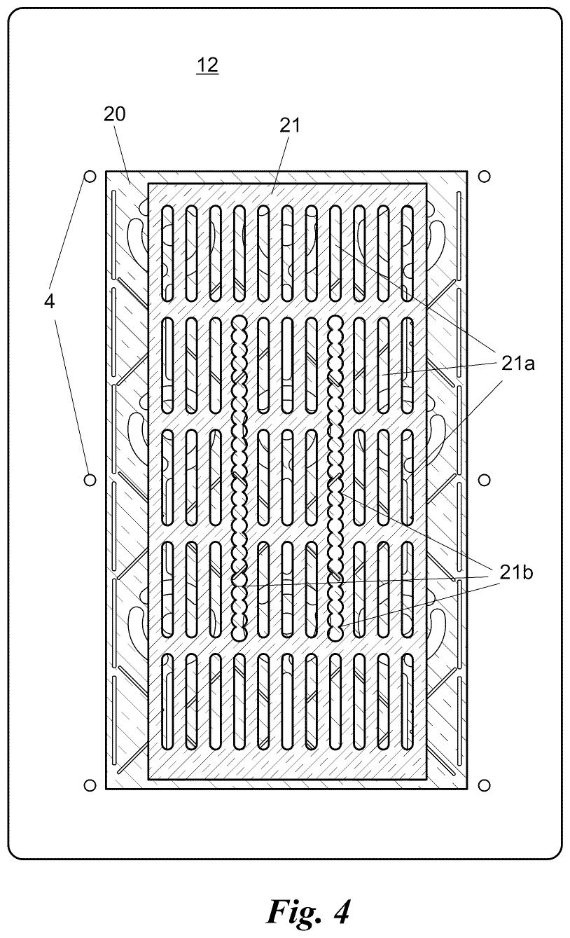

FIG. 4 shows the bottom view of the interior of the container cassette according to the invention; and

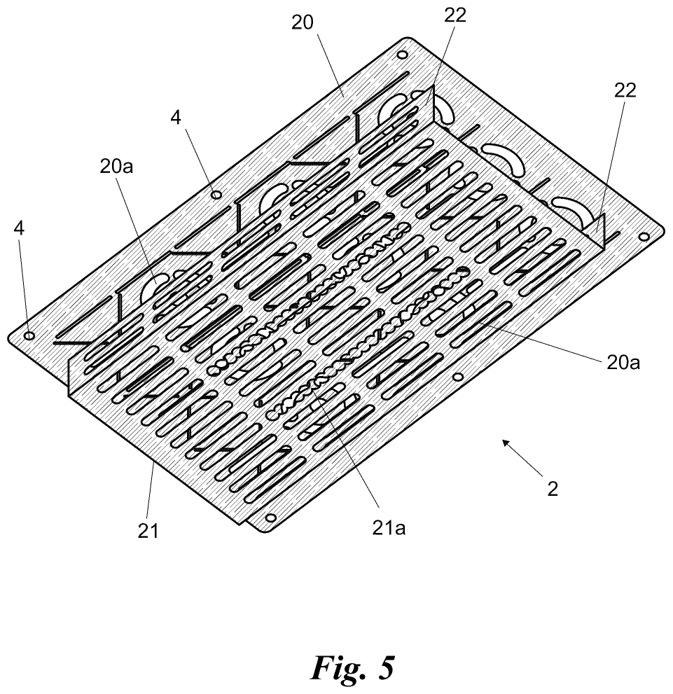

FIG. 5 shows an axonometric view of a portion of the container cassette according to the invention.

In this document, when measurements, values, shapes, and geometric references (such as perpendicularity and parallelism) are associated with words like “approximately” or other similar terms, such as “almost” or “substantially”, they shall be understood as except for errors of measurement or imprecisions due to errors of production and/or manufacturing and, above all, except for a slight departure from the value, measurement, shape, or geometric reference with which it is associated. For example, if associated with a value, such terms preferably indicate a departure of no more than 10% of the value itself.

Furthermore, when terms such as “first”, “second”, “upper”, “lower”, “main”, and “secondary” are used, they do not necessarily identify an order, relationship priority, or relative position, but they can simply be used to distinguish different components more clearly from one another.

Unless otherwise specified, as reflected in the following discussions, terms such as “processing”, “computing”, “determination”, “computation”, or the like are considered to refer to the action and/or processes of a computer or similar electronic computing device that manipulates and/or transforms data represented as physical, such as electronic quantities of records of a computer system and/or memories, in other data similarly represented as physical quantities within computer systems, records, or other information storage, transmission, or display devices.

Unless otherwise stated, the measurements and data reported in this text shall be considered as performed in International Standard Atmosphere ICAO (ISO 2533:1975).

With reference to the Figures, the reference number 1 indicates, as a whole, the security container cassette for banknotes and valuables, in particular a cassette for cash machines, ATMs and the like, according to the invention.

The security container cassette 1 preferably consists of a cassette for cash machines, ATMs, and the like and is suitable for containing banknotes 50. The security container cassette 1 preferably includes perimeter walls 10 suitable for defining an internal volume 1a.

The perimeter walls 10 define a preferably substantially parallelepiped-shaped case and fitted with a lid 14 suitable for providing access to the internal volume. The perimeter walls 10 are preferably made of polymeric material.

In more detail, the perimeter walls 10 include an upper wall 11.

The upper wall 11, which in use can be horizontal or vertical, is preferably structurally part of the lid 14. Opposite the main wall there is preferably a support base 15 for banknotes and valuables 50.

In addition, preferably, the upper wall 11 runs along an upper surface 11a preferably flat and includes a frame 12 structurally in one piece with at least part of the other perimeter walls 10, and a main opening 13 occupying most, and preferably at least ⅔, of the upper wall 10.

The security container cassette 1 also preferably includes a main container 2 arranged in the internal volume 1a and in the opening 13.

The main container 2 preferably includes: an upper wall or side 20 developing along the upper surface 11a and preferably covering the entirety of the main opening 13 and at least part of the frame 12; a lower wall or side 21 arranged within the main volume 1a; and side walls 22 suitable for connecting the upper side 20 and the lower side 21.

The main container 2 is preferably in the shape of a parallelepiped. It is also considerably lower in height, that is, the dimension perpendicular to the upper surface 11a, than the height of the cassette 1 and preferably between 1 cm and 5 cm. In contrast, the dimensions parallel to the upper surface 11a are preferably close to the dimensions of the cassette 1. Furthermore, preferably, the lower side 21 has a smaller main surface area than the area of the main opening 13 so that it can pass through said main opening 13. Basically, the main container can be seen as a box container with an upper side with a flange that expands along the surface of the side itself, coinciding with the upper surface 11a. Preferably, the lower side 21 is arranged above the area occupied by said banknotes or valuables 50. In addition, preferably the upper wall 11 is in one piece, and the lower wall 21 and side walls 22 are made from a sheet that is folded and welded or otherwise joined to the upper side 21.

Preferably, the main container 2 is made of metal, ideally of steel. It is preferably less than one millimeter thick. Basically, the main container 2 is preferably made of sheet metal.

Cassette 1 also preferably includes constraint means 4, such as screws or glue or otherwise, suitable for rigidly constraining the upper side 20 to the frame 12. This constraint occurs appropriately along the overlap between the frame 12 and the upper side 20. The latter is preferably placed above the frame 12.

In addition, preferably, the upper side 20 includes upper pass-through openings 20a preferably having the function and structure described in paragraphs 42-46 and 60-61 of the applicant's own patent EP3761276B1, i.e. to allow the immediate and direct passage of shock waves from any break-ins. They are therefore preferably present along the entire surface of the main container 2. They can be covered in low strength material, for example an adhesive tape made of polymeric material or paper, or polyethylene, or something else.

Preferably, the upper openings 20a have the shapes and designs shown in FIG. 3. For example, they include a series of circumferentially and radially interrupted circular holes and a series of linear segments aligned with the long edges of the cassette and also a series of segments at 45 degrees with respect to them.

In addition, preferably, the lower side 21 includes lower pass-through openings 21a, preferably having the main function of allowing the passage of liquids from the internal volume to the container 2 to the banknotes. They may also include rupture elements 21b having the structure described in paragraphs 35-37 of the applicant's own patent EP3761276B1. They preferably consist of sharp edges suitable for cutting the internal container described below in the event of a collision.

Preferably, the upper openings 20a have the shapes and designs shown in FIG. 4. For example, they include a series of linear segments aligned with the long edges of the cassette and openings with rupture elements consisting of a series of consecutive holes that create sharp edges and are placed in the areas above the banknotes 50 so that the second container 3 is cut into appropriate areas and all banknotes 50 are marked.

Finally, the container cassette 1 includes an internal container 3 inside said main container 2, which is fluid-tight and configured to hold marking fluid. It preferably has the function and structure described in paragraphs 31-34 of patent EP3761276B1 and may include banknote marking ink and also rupture elements such as those described in paragraphs 46, 61 of patent EP3761276B1. Thus, the internal container 3 is preferably designed for the marking fluid, fluid-tight and contained in the main container 2. Said internal container 3 is preferably of the pliable type and can easily be ruptured in case of pressurisation from explosions or the like. It can be made, for example, of one or more membranes with low mechanical strength, for example polyethylene, and with a thickness in the order of tenths of millimetres or other.

The second container 3 is then inserted into the main container 2 and preferably occupies most of its internal volume above the banknotes. There may also be a plurality of second containers 3 arranged over most of the internal volume of the main container 2 above the banknotes.

The construction of the container cassette 1 described defines an innovative procedure for making a container cassette 1 for cash machines, ATMs or the like. This procedure involves the after-market modification of a traditional type of cassette.

In such a traditional cassette, only the main opening 13 is provided.

At the same time, a sheet metal is shaped appropriately, bent and welded simply by means known to the skilled person, so as to form said main container 2.

At the same time, the internal container 3 is also realized according to the known art. It is then placed inside the main container 2, for example through a missing side 22, and is left there and possibly glued to the main container 2 so that it remains fixed in a suitable position.

The main container 2 is then inserted from above inside the main opening 13 so that the lower side 21 is in the internal volume and the flange formed by the upper side 20 is opposed to the frame 12.

Then, with constraint means 4, the upper side 20 and the frame 12 are joined.

The operation of the security container cassette 1 described above in structural terms, is similar to the operation of the cassette described in patent EP3761276B1 described in paragraphs 58-66.

The container cassette 1 according to this invention achieves important advantages. In fact, cassette 1 is safe and easy to apply even as an aftermarket modification. In addition, the reduced thickness of the sides of the main container 2 allows the upper side 20 to be placed above the frame 12 without substantially changing the thickness of the cassette 1.

Variations may be made to the invention that fall within the scope of the inventive concept defined in the claims. In this context, all details can be replaced by equivalent elements, and the materials, shapes, and dimensions may be any materials, shapes, and dimensions.

1. A security container cassette (1) for banknotes or valuables (50) for Bancomat (i.e. cash machines) or ATMs, defining an internal volume (1a) and comprising perimeter walls (10) including an upper wall (11):
said upper wall (11) developing along an upper surface (11a) and comprising:
a frame (12) structurally in one piece with at least part of other said perimeter walls (10),
a main opening (13) occupying most of said upper wall (10),
a main container (2) arranged in said internal volume (1a) and in said main opening (13) and comprising:
an upper side (20) developing along said upper surface (11a) and covering said main opening (13) and at least part of said frame (12), said upper side being provided with passing through upper openings (20a),
a lower side (21), arranged within said main volume (1a) and comprising passing through lower openings (21a),
side walls (22) suitable for connecting said upper side (20) and said lower side (21),
constraint means (4) suitable for rigidly constraining said upper side (20) to said frame (12).
an internal container (3) inside said main container (2), which is fluid-tight and configured to hold marking fluid.

2. Container cassette (1) according to claim 1, wherein said main container (2) is made of metal.

3. Container cassette (1) according to claim 2, wherein said main container (2) has walls less than 1 mm thick.

4. Container cassette (1) according to claim 1, wherein said perimeter walls (10) are made of polymeric material.

5. Container cassette (1) according to claim 1, wherein said upper side (20) is in one piece.

6. Container cassette (1) according to claim 1, wherein said lower side 21 has a smaller main surface area than the area of said main opening (13) so that it can pass through said main opening (13).

7. Container cassette (1) according to claim 1, wherein said pass-through lower openings (21a) include sharp edges suitable for cutting said internal container (3) in the event of impact.

8. Container cassette (1) according to claim 1, wherein said lower side (21) is arranged above the area occupied by said banknotes or valuables (50).

9. Container cassette (1) according to claim 1, wherein said main opening (13) occupies at least ⅔ of said upper part (11).

10. Container cassette (1) according to claim 1, wherein said upper part (11) is arranged along a lid (14) of said cassette.
